(19) United States
(12) Patent Application Publication
(10) Pub. No.: US 2003/0120826 A1
(43) Pub. Date: Jun. 26, 2003

(54) System and method for building a communication platform for the telematics domain using a distribution of network objects

(76) Inventor: Amir Shay, Modiin (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(21) Appl. No.: 10/022,518

(22) Filed: Dec. 20, 2001

(51) Int. Cl. G06F 9/00; G06F 9/46

(52) U.S. Cl. 709/316

(57) ABSTRACT

According to the present invention there is provided a system for enabling Wireless Wide Area Network (W²AN) communication capable of aggregating and disseminating information for the Telematics domain, without the need of additional external network infrastructure, such as communication towers and central switch. The invention offers a new method for Telematics W²AN (TW²AN), wherein each Network Object communicates only with Network Objects in its immediate surrounding using WLAN/PAN technologies (Bluetooth, 802.11 a/b, DSRC, DECT). The information reaches remote Network Objects by continues exchanges of information between close Network Objects using WLAN/PAN technology. The invention present includes an Aggregating Disseminating Communication Component (ADCC) that is added to each Network Object. The ADCC collects traffic related information and builds an internal traffic map of the area. The underlying Network Object can initiate transmission of information using the ADCC to TW²AN. The ADCC is capable of receiving information, if needed the received information is updated the underlying Network Object and then exchanged to the next Network Object.

### FIELD AND BACKGROUND OF THE INVENTION

1. Field of the Invention

The present invention relates to a system for providing a platform for a Wireless Wide Area Network (W²AN), enabling communication, aggregating and disseminating of information using existing Wireless Local Area Networks (WLAN/PAN) technology.

2. Description of the Related Art

Many attempts have been made in recent years to develop data networks that can effectively transfer data between a multitude of user devices. Typical Local Area Networks (LANs) are communications networks that serve users within a confined geographical area. They are made up of servers, workstations, a network operating system and a communications link. WANs (Wide Area Networks) are communications networks that cover a wide geographic area, such as state or country. A LAN (local area network) is typically contained within a building or complex, and a MAN (metropolitan area network) generally covers a city or suburb. These networks have enabled the connection of multiple computers, such that all connected computers and devices can transfer data between them. One of the limitations, however, of these types of networks, is that they require connectable devices to be physically connected to the network. Such networks require connection hardware and software components in order to join compatible devices, demanding extra hardware, software and setup costs.

A more recent alternative to wire-based networks are wireless networks. An example is a Wireless Personal Area Network (WPAN), which is a wireless network that serves a single person or small workgroup. It has a limited range and is used to transfer data between, for example, a laptop or PDA and a desktop machine, server or printer. Similar to the way a cordless phone works with its base station, technologies such as Bluetooth and WIreless FIdelity (Wi-Fi) are expected to be deployed in dual mode smart phones that can download e-mail and Web data while on the road and then exchange that data with a laptop or desktop machine in the office.

In response to the need for larger scale wireless networks, the following technologies have been developed:

Wireless LAN is a local area network that transmits data wirelessly, typically in an unlicensed frequency such as the 2.4 GHz band. A wireless LAN does not require lining up devices for line of sight transmission like IrDA. Wireless access points (base stations) are connected to an Ethernet hub or server and transmit a radio frequency over an area of several hundred to a thousand feet which can penetrate walls and other non-metal barriers. Roaming users can be handed off from one access point to another like a cellular phone system. Laptops use wireless modems that plug into an existing Ethernet port or that are self contained on PC cards, while stand-alone desktops and servers use plug-in cards (ISA, PCI, etc.). Wireless LANs function like cellular telephone systems. Each access point is a base station that transmits over a radius of several hundred feet. In systems designed for office use, users can seamlessly roam between access points without dropping the connection. Wireless LAN coverage is, however, limited to the base station's transmission range, which is usually up to several hundred feet. In addition, there are substantial hardware requirements in order to set up such as system, resulting in considerable cost and complexity.

HOME Radio Frequency: A wireless personal area network (PAN) technology from the HomeRF Working Group, Portland, Oreg., (www.homerf.org), founded in 1998 by Compaq, IBM, HP and others. HomeRF uses the Shared Wireless Access Protocol (SWAP) and provides an open standard for short-range transmission of digital voice and data between mobile devices (laptops, PDAs, phones) and desktop devices. Transmitting in the unlicensed 2.4 GHz range, up to 127 devices can be addressed within a range of 150 feet at a data rate of 1 or 2 Mbps. Derived from the Digital European Cordless Telephone (DECT) standard, HomeRF uses a frequency hopping technique that changes 50 times per second. Each 20 ms frame contains one CSMA/CA slot (typically for data) and six full-duplex TDMA slots (typically for voice).

HIPERLAN: A wireless LAN protocol developed by ETSI that provides a 23.5 Mbps data rate in the 5 GHz band. It is similar to Ethernet, but unlike 802.11a, the wireless Ethernet standard at the same rate, HIPERLAN/1 provides quality of service (QoS), which lets critical traffic be prioritized. Other versions of HIPERLAN are expected including HiperLAN/2 and HIPERAccess for wireless ATM and wireless local loop in the 20 Mbps range, and HIPERlink for wireless point-to-point in the 155 Mbps range.

802.11—A family of IEEE standards for wireless LANs first introduced in 1997 also know as Wi-Fi. 802.11 uses either a frequency hopping modulation (FHSS) technique or direct sequence spread spectrum (DSSS), which is also known as CDMA. 802.11b defines an 11 Mbps data rate in the 2.4 GHz band, and 802.11a defines 24 Mbps in the 5 GHz band.

Bluetooth—A wireless personal area network (PAN) technology from the Bluetooth Special Interest Group, (www.bluetooth.com), founded in 1998 by Ericsson, IBM, Intel, Nokia and Toshiba. Bluetooth is an open standard for short-range transmission of digital voice and data between mobile devices (laptops, PDAs, phones) and desktop devices. It supports point-to-point and multipoint applications. Bluetooth currently provides up to 720 Kbps data transfer within a range of 10 meters and up to 100 meters with a power boost. Unlike IrDA, which requires that devices be aimed at each other (line of sight), Bluetooth uses omni directional radio waves that can transmit through walls and other non-metal barriers. Bluetooth transmits in the unlicensed 2.4 GHz band and uses a frequency hopping spread spectrum technique that changes its signal 1600 times per second. If there is interference from other devices, the transmission does not stop, but its speed is downgraded. The name Bluetooth comes from King Harald Blatan (Bluetooth) of Denmark. In the 10th century, he began to Christianize the country. Ericsson (Scandinavian company) was the first to develop this specification.

The main objectives of HomeRF, HiperLAN and 802.11, are to provide WLAN inside buildings, and in the case of Bluetooth, the main objective is to provide ad-hoc connections between devices. These technologies do not provide means to expand network functionality in a WAN.

Peer-to-peer network is a communications model in which each party has the same capabilities and either party can initiate a communication session. Other models with which it might be contrasted include the client/server model and the master/slave model. In some cases, peer-to-peer communications are implemented by giving each communication node both server and client capabilities and hence there is no need for external supervision mechanism.

Global Positioning System—With a GPS receiver, a user's location can be pinpointed, in latitude and longitude, anywhere on the Earth. In addition, one can obtain the precise time. GPS was once limited to military use only, and accuracy was purposely limited for civilian use. However, since May 2000, the induced error has been eliminated and civilian GPS receivers have become much more accurate. Due to technological advancements, GPS receivers have come down drastically in cost, size, and power consumption, to the point where handheld versions are readily available. At the same time, their accuracy has improved due to better error correction using advanced methodology, as well as from the government lifting restrictions.

U.S. Pat. No. 6,012,012, of Fleck et. al., which is fully incorporated herein by reference, describes a method and system for determination of dynamic traffic information or traffic events. Relevant data from vehicle-mounted terminals are recorded automatically, by remote interrogation or manually, and transmitted directly, together with a location identifier, via a wide-coverage mobile-telephone network, for example, GSM, to other mobile-telephone subscribers and/or a higher-level exchange. In the exchange, the incoming data is processed and fed to selected terminals and/or third parties. In addition, the results of interrogation, for example, braking behavior, can be pre-defined by a traffic-control center and transmitted by radio broadcast or mobile telephone system to the terminals of road users in a geographically limited area who can then “observe” the flow of traffic directly and immediately report incoming interrogation results by mobile telephone back to the exchange. The transmission of traffic information to the central location using cellular networks, according to the Fleck et. al. invention, can be divided into two different operations—aggregation (collecting information) and dissemination (distributing the information). This invention is limited in that a central processing component is required to aggregate the information, process it and then disseminate the processed information to the vehicles. The central structure of this invention raise the problems of communication costs and resource usage, to get accurate traffic information thousands of cars in each area need to send information every few minutes. Then the invention needs a communication system to send traffic information to all the vehicles. Another problem is associated with the fact that the drivers in the vehicles need to send their location to the network in the aggregation and dissemination process.

U.S. Pat. No. 6,104,712, of Robert et al. describe a network of moving objects, where each node is capable of receiving and transmitting voice and data using short-range wireless networking. To keep track of the moving nodes location, a routing protocol is used. The routing protocol requires each node to broadcast its location to a central database. When there is a communication to a node, the transmitter first needs to find the receiver location by querying the location database. The limitation of this invention is that it also requires some central control mechanism, leading to increase costs and compromising privacy. Another limitation of this invention is that it requires fairly large density of distributed objects, each communication requiring a chain of connection between the transmitting objects and the destination object.

Furthermore, in the Telematics domain there exist several technologies that enable traffic management and/or notification systems, which include aggregation and dissemination of traffic data.

Competing Aggregation Methods:

i. Roadside traffic sensors, from Mobility Technologies (851 Duportail Road, Suite 220 Wayne, Pa. 19087, www.mobilitytechnologies.com). These provide data aggregation in circumstances where no hardware is required in the vehicle, such that all vehicles can be tracked, there are moderate per-city build out costs, and they provide one-of the only ways to get lane by lane data. The disadvantage is that there is no real possibility for quick national build out, as state-by-state approval is needed. Furthermore such a system is ill suited for full national coverage, as only large roads are worth being covered.

ii. Toll tag tracking using billboards, by AmTech (TransCore) (Tour Leopold rue de Geneve 10, 1140 Brussels, www.transcore.com). Such a system provides advantages including low transmission costs and low hardware costs. However, such a system has no real-time positioning capabilities, and general traffic flow is all that is provided.

iii. GPS and related technologies, by TrafficMaster (University Way, Cranfield, Bedfordshire MK43 0TR, www.trafficmaster.co.uk). These technologies provide automotive OEMs with relatively low vehicle-related hardware costs, and an ability to track location with excellent accuracy and precision. However, GPS is a one-way transmission process, where transmission costs on alternate networks, such as cellular, are high.

iv. Cell phone tracking (using towers), by US Wireless Cell-Loc (Suite #220, Franklin Atrium, 3015-5th Avenue N.E., Calgary, AB T2A 6T8, www.cell-loc.com) provides true position with low transmission costs, and no changes are required to existing handsets or cellular infrastructure. However such technology is inferior to GPS in accuracy and precision.

v. Cell phone tracking (using handsets), by QualComm (5775 Morehouse Drive San Diego, Calif. 92121, www.qualcomm.com), provides excellent tracking precision and accuracy. However, handsets require changes and added costs, there are high transmission costs, and a system is vulnerable to legislation banning cell phone use in the vehicle.

Competing Dissemination Methods

i. Cellular Networks by various Cellular providers enable working with existing handsets and PDAs. However, current networks are not “always on”, and they provide Low bandwidth at high airtime costs.

ii. FM radio provides data dissemination with low airtime costs and high bandwidth. However there is a need to add a special receiver, and equipment is only suitable for broadcasting.

There is thus a widely recognized need for, and it would be highly advantageous to have, a communication platform that can provide aggregation and dissemination capabilities between network objects, at low costs, with high bandwidth, while maintaining user privacy and providing a turnkey solution independent of cellular networks. Such a platform should furthermore be able to function without centralized processing components, such that it should be able to be formed with extremely low setup costs, and it should provide location based services efficiently even in the case of low density of Network Objects.

### SUMMARY OF THE INVENTION

According to the present invention there is provided a system for enabling wireless technology means to form a Wireless Wide Area Network (W²AN). Furthermore, there is provided a means for aggregating and disseminating information for the Telematics domain, without the need for additional external infrastructure, such as communication towers and central switches. More particularly, the present invention offers a new method for such a Telematics Wireless Wide Area Network (hereinafter referred to as “TW²AN”), wherein each Network Object communicates only with other Network Objects in its immediate surrounding using existing WLAN/PAN technologies (Bluetooth, 802.11a/b, DSRC, DECT). The information reaches remote Network Objects by continuous wireless communication exchanges of information of the Network Objects.

According to the present invention, the following terms and abbreviations are used:

Wireless Wide Area Network (W²AN)

Telematics—refers to the convergence of telecommunications and information processing in all types of vehicles (including automobile, aviation and marine systems). This operates by providing two-way voice and data communication and services to a vehicle, and potentially its driver and its passengers. This includes cars, trucks, buses, boats, airplanes, satellites, submarines etc.

Telematics Wireless Wide Area Network (TW²AN)

Network Object—refers to every Object, element or entity that plays a role in the W²AN.

Underlying Network Object Means or Underlying Computer System (UCS)—This refers to the Telematics or alternative computer system of the Network Object, that provides the basic processing and data storage for the Network Object. The UCS has bi-directional connection to the ADCC

Telematics Systems (TS) is a special case of UCS where the Network Object is a vehicle.

Aggregating Disseminating Communication Component (ADCC)

Main Control and Algorithm Unit (MCAU)

Traffic Status Record (TSR)

Traffic Status Map (TSM), which is a collection of TSRs.

Service Information Message (SIM)

Service Information Table (SIT), which is a plurality of SIMs.

Instant Information Messages (IIM)

Instant Information Table (IIT), which is a plurality of IIMs.

Broadcast IIM (BIIM)

Narrowcast IIM (NIIM), which refers to transmitting data to specific or selected Network objects.

Available Information Table (AIT)

List of Available Messages (LAM)

The present invention includes an Aggregating Disseminating Communication Component (ADCC) that is added to each Network Object in the network that is being formed. The ADCC, according to a preferred embodiment of the present invention, collects traffic related information and other object data, and builds an internal traffic map for the object, that relates to the object's surrounding area. The combination of different objects surrounding areas eventually enables the formation of a Wireless Wide Area Network (W²AN), such that a Telematics related network of this type is referred to as a TW²AN. The ADCC also provides the underlying Network Object with the means to publish various types of information on the TW²AN (such as opening hours, location, available products and services). The ADCC is capable of receiving information from the TW²AN, merging the prior information with the ADCC current information, updating the new information in a Network Object, and subsequently exchanging the updated received information or aggregated information from the underline network object with other Network Objects.

The network is composed of mobile Network Objects (vehicles) and stationary Network Objects (business, maintenance locations etc.) By using wireless communication between the various Network Objects, the proposed network is able to provide:

Updated traffic and road condition information

Location based information about services such as gas station, tourist attraction, parking garage, weather stations, control towers and lighthouses.

Communication platform for bi-directional m-commerce between vehicles and services available in the area.

Communication Infrastructure for navigation-maps updates and maintenance.

The proposed network provides the above functionality by carrying at least three types of location-based information:

Traffic Status Map (TSM): A map of traffic and road conditions in the surrounding area

Service Information Messages (SIM): Information about available services in the surrounding area

Instant Information Messages (IIM): Messages between different Network Objects

The wireless communication range is from few meters up to few kilometers. Using the movement of vehicles and continues exchange of information between Network Objects, the information is transferred in the range of several hundreds of kilometers, depending on the region and the Network Object layout in this area.

The aggregating disseminating communication component (ADCC) of the present invention further comprises:

i. Main Control and Algorithm Unit (MCAU), comprising software and hardware, controlling the ADCC and implementing the algorithms that enable the TW²AN.

ii. Tables and data stores used to store information used by the MCAU.

iii. WLAN/PAN unit use to communicate with other Network Objects. If the underlying Network Object has an available WLAN/PAN unit, the ADCC uses this unit. In other cases, the ADCC includes a separate WLAN/PAN unit.

iv. A geo-location detector, such a GPS, used to read the Network Object's location, for dynamic objects. Similarly to the WLAN/PAN unit, if the underlying Network Object does not have an available GPS unit, the ADCC includes a separate one. Stationary objects do not need GPS, as their location is pre configured at setup, according to the stationary object's location.

v. Integration with the underlying-Network Objects computer/processing/communications systems. In vehicles, the ADCC integrates with the Telematics Systems (TS). In other cases, the integration is with the Underlying Computerized Systems (UCS). The integration between the ADCC and the TS or UCS depends on the Network Object's hardware, software and functionality and is customized according to the Network Object's characteristics.

According to the present invention, the following method is utilized:

i. The ADCC in each vehicle constantly reads, processes (aggregates) and stores the particular vehicles past and present traffic and road conditions data (such as velocity, direction, weather conditions), thereby compiling a current traffic status map (TSM), which is regularly updated.

ii. The ADCC in a Network object reads the service information that a Network object publishes, from the TS or UCS, and stores this SIM in the service information table (SIT).

iii. Network Objects can furthermore request of their ADCC to send instant information messages (IIM) to other Network Objects in proximity. The IIM is stored in the SIT.

iv. The ADCC of each vehicle in a TW²AN network broadcasts and/or publishes this TSM and the SIM and IIM in the SIT, to other remote Network Objects in its proximity.

v. A receiving ADCC listens to the communication line and waits for communication from other ADCCs.

vi. The receiving ADCC enters into receive state in order to receive incoming information/data that can be TSM, SIM or IIM.

vii. The receiving ADCC receives information and is updated with new data

viii. If required, a new TSM is built, by merging the existing TSM and the one received.

ix. If required, the received TSM is transferred to the vehicle Telematics system (TS) or Network Object underlying computerized system (UCS).

x. If required, the received SIM and IIM are merged with the existing SIM and IIM.

xi. If required, the received SIM and IIM are transferred to the vehicle Telematics system (TS) or Network Object underlying computerized system (UCS).

xii. The receiving ADCC enters into transmit state to transfer the newly merged TSM, SIM and IIM to the surrounding Network Objects.

xiii. Alternatively, the receiving ADCC can also enter into the transmit state if predefined events occur, such that a transmit query is satisfied.

Innovations:

The W²AN infrastructure, according to the present invention, enables, for example, (but is not limited to) the following applications:

Enabling automobiles to exchange information about traffic and road condition in the surrounding area. The traffic information parameters include Velocity, Direction of movement, Lights status, Wiper status, Tracking system status and Engine RPM. Additionally, businesses or service centers can publish information about available services in the surrounding area. The types of businesses include, service stations, parking garages, tourists attractions, maintenance centers etc.

Enabling marine vehicles (boats etc) to exchange information in a way similar to the described system for automobiles. Instead of traffic information, the marine information includes parameters such as: sea level wind, temperature, barometric pressure etc. The type of businesses or service centers that may publish information include weather stations, lighthouse maintenance centers, coast guard, marine maintenance centers, etc.

Enabling aviation entities, such as flying vehicles, airplanes, satellites etc., to exchange information in a way similar to the described system for automobiles. Instead of traffic information, the aviation information may include parameters such as: storms, clouds, temperature, wind, barometric pressure etc. The type of business that publish information includes weather stations, airports, maintenance centers etc.

Advantages:

The special configuration of the present invention differentiates it from other wireless network solutions because other solutions require extensive physical infrastructure, such as communication towers; switches; heavily personnel dependent call centers; infrastructure maintenance centers and licensed radio frequencies. The lack of infrastructure expenses allows the company to introduce the platform to consumers at substantially lower prices.

In the present invention, information is not routed through a central switch, but is transferred directly between Network Objects. This ensures the user's privacy. Rarely and only according to specific user requests, is the Network Object's location transmitted to TW²AN.

Unlike the other solutions that require a combination of methods, for example, aggregating information using cellular network and disseminating it using the radio, the proposed invention is complete and global. The solution of the present invention does not depend on regional cellular network operators/types or radio operators.

The present invention offers the various players in the Telematics market a turnkey solution that is independent of cellular providers, cellular methods (GSM, TDMA, CDMA, etc) or radio providers. This further differentiates the present invention from known Telematics systems, which typically need to have special configurations, hardware and agreements, for different regions, according to the region's cellular methods and cellular providers.

The present invention's unique platform ensures that the traffic status is updated frequently, while in competing solutions, frequent updates are usually too costly and can flood the communications infrastructure.

The present invention offers a solution that operates efficiently with a relatively low density of Network Objects, as compared to other solutions that do not rely on additional external infrastructure. Other solutions without infrastructure require permanent connections between system objects for the information to propagate. Each transmission either to another system objects or to objects on other networks requires a routing mechanism that involves connectivity to the fixed network. This connectivity is not feasible without a permanent connection between a high density of network objects.

### BRIEF DESCRIPTION OF THE DRAWINGS

The invention is herein described, by way of example only, with reference to the accompanying drawings, wherein:

FIG. 1 is an illustration of the network structure and its main components.

FIG. 2 is an illustration of the integration of the proposed invention inside a vehicle.

FIG. 3 is an illustration of the integration of the proposed invention inside stationary network objects

FIG. 4 is an illustration of the general flow of operations according to the present invention.

FIG. 5 is an illustration of the communication dialog between ADCC.

FIG. 6 is an illustration of how traffic map is transferred.

### DESCRIPTION OF THE PREFERRED EMBODIMENT

According to the present invention there is provided system for enabling Wireless Wide Area Network (W²AN) data communication, based on wireless communications technologies. Furthermore, a preferred embodiment of the present invention enables aggregating and wireless disseminating of information for the Telematics domain without the need for external infrastructure, such as communication towers, centralized data processors and a central switch.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention provides a new method for developing a Wireless WAN enabling communication for the Telematics domain, such that a Telematics Wireless Wide Area Network (TW²AN) is formed. Each Network Object in the TW²AN communicates with other Network Objects in its immediate vicinity, using WLAN/PAN technologies (such as Bluetooth, 802.11b, DSRC, DECT). The information reaches remote Network Objects by continuous exchange of information between moving and stationary Network Objects. While the WLAN/PAN range is up to few kilometers the proposed network can aggregate and disseminate information in the range of several hundreds of kilometers covering an area of interest, for example the metropolitan area of specific city.

The proposed network is able to provide:

Updated traffic and road condition information

Location based information about services such as gas stations, tourist attractions, parking garages, weather stations, control towers and lighthouses.

Communication platform for bi-directional m-commerce between vehicles and services available in the area.

Communication Infrastructure for navigation-maps, updates and maintenance.

The proposed network provides the above functionality by carrying at least three types of location-based information

Traffic Status Map (TSM): A map of traffic and road conditions in the surrounding area

Service Information Messages (SIM): Information about available services in the surrounding area

Instant Information Messages (IIM): Messages between different Network Objects

The principles and operation of a system and a method according to the present invention may be better understood with reference to the drawings and the accompanying description, it being understood that these drawings are given for illustrative purposes only and are not meant to be limiting, wherein:

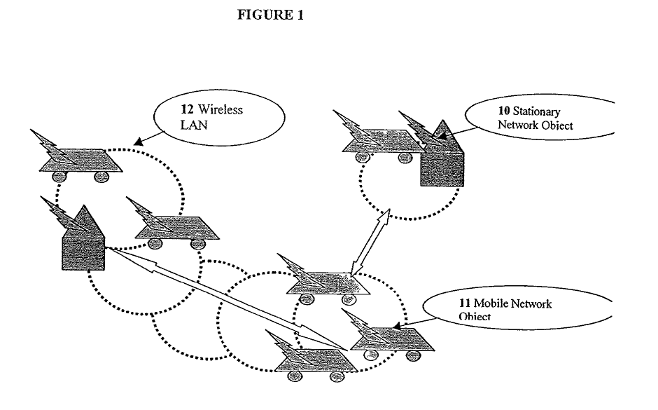

As can be seen in FIG. 1, the network incorporates stationary Network Objects 10 and mobile Network Objects 11, all equipped with an aggregation dissemination communication component (ADCC). According to a first preferred embodiment of the present invention, the mobile Network Objects are vehicles and the stationary Network Objects are fixed service locations such as hotels, parking garages, information stations, restaurants and maintenance centers When two Network Objects meet in the WLAN/PAN range 12, their respective ADCCs exchange information. Continuous exchange of information along the movement of the vehicles enables the propagation of information in the W²AN range.

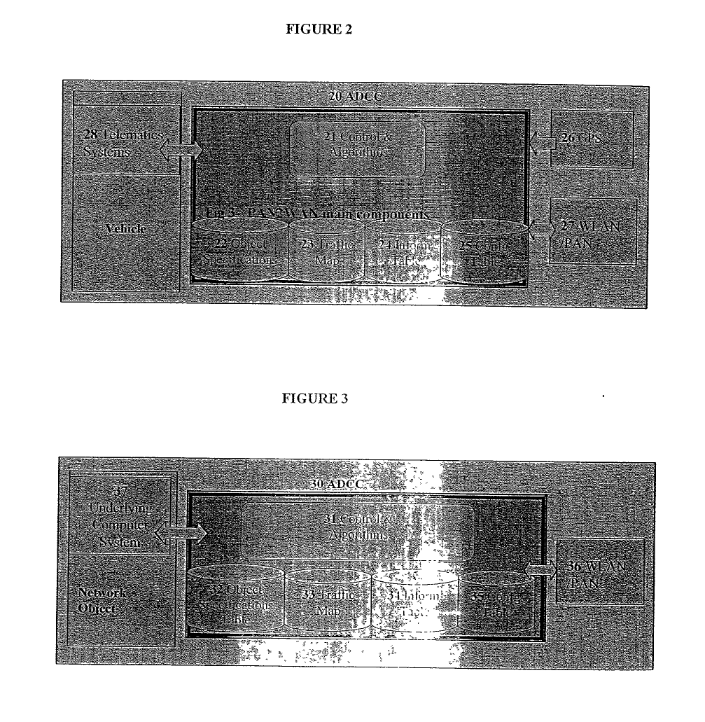

FIG. 2 illustrates vehicle ADCC Integration and outlines the integration of ADCC inside the vehicle. The ADCC 20 is composed of a main control and algorithm unit 21 (MCAU) that controls the operations and is responsible for executing the various processes of the present invention. The ADCC also has four main data containers: the object specifications table 22, the traffic map table 23, the information table 24 and the configuration table 25.

The object specifications tables 22 and 32 contain information that the vehicle wants to publish and broadcast to the network. This information is taken from the underlying computerized system (UCS). The object specifications table is more relevant in stationary Network Objects 32 than dynamic Network Objects 22. Some of the information in this table is static and doesn't change too often, for example opening hours, and some is dynamic and is fetched from the underlying Network Object for each user request, such as a response to a query about parking availability.

The Traffic map tables 23 and 33 contain the current traffic map of the Network Object, which is composed of traffic-based information derived from the vehicle's Telematics systems and information received from other Network Objects. Unlike vehicles, stationary Network Objects do not typically contribute information to the traffic map, and the Traffic map table 33 in stationary Network Objects is used to merge information from different Network Objects and forward it to other Network Objects.

The information tables 24 and 34 contain the different information messages, SIM, and IIM, published by other Network Objects and received by the ADCC. This information is stored and published in order to provide other Network Objects with relevant information. Where relevant, the received information is transferred from the information table 24 or 34 to the Telematics system (TS) or underlying computerized system (UCS).

Typically, an ADCC can store a defined number (or limited data quantity) of TSMs, SIMs and IIMs. The ADCC constantly stores the last defined number of messages or percentage of data that has been received or composed by the Network Object internally, emptying out the previous data in the memory, when necessary, to make space for more recent composed and received data and messages. Optionally, a dynamic allocation table is used in order to allocate memory to the various data tables, according to demand. For example, such a mechanism may reserve larger space for TSM and smaller space for SIM, or vice versa. A practical example may be where the memory capacity of the information table 24 may be 2MB, in which case it would store up to 2 MB of data, after which time each new request to receive more data would require prior deletion of data already in the table. The data deleted is typically the first data to be received, according to a basic First In First Out (FIFO) mechanism in accordance to the information priority and time/space to live (as will be described below) The configuration table 25 contains configuration information used by the main control and algorithm unit 20. The configuration information is programmed during initial setup of the system and wirelessly during system operation. ADCC reads the Network Object's location from the GPS 26 module. The WLAN/PAN communication device 27 is used to communicate and transfer information to other Network Objects. The present invention uses PAN/WLAN technologies (such as Bluetooth, 802.11 a/b, DSRC, DECT) in order to communicate data to the wireless network. The vehicle Telematics system 28 serves as the mediator between ADCC and the user, and the ADCC's integration with the vehicle Telematics system is bi-directional. ADCC 20 reads parameters from the Telematics system and records them in the traffic map table 23, parameters such as vehicle velocity, wiper speed, tracking system status, lights status and engine RPM. Once the ADCC has a relevant traffic map, built by merging the internal TSM with TSM received from other Network Objects, it is transferred to the Telematics system 28 that can present it to the driver. The ADCC 20 also transfers business information and messages to the Telematics system 28, from the information table 24. The user can request specific information from the Telematics system, for example “make a reservation for parking garage”. This request is transferred from the Telematics system 28 to ADCC 20, which is responsible for sending the request to the desirable location using the WLAN/PAN 27.

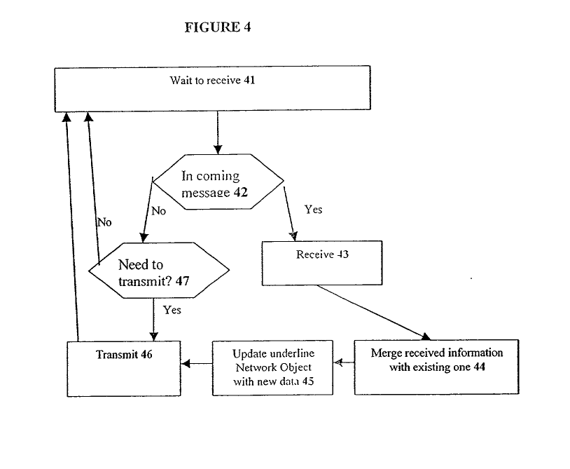

FIG. 3 illustrates ADCC integration inside stationary Network Objects. The stationary Network Object can be a business or alternative service entity that wants to publish its services to vehicles in the surrounding region. Some examples are hotels publishing information about available rooms, parking garages looking for customers, restaurants offering their services, service stations, information stations etc. Other types of stationary Network Objects are maintenance centers that are used to send software updates; navigation maps updates; tracking billing information; configuration parameters etc. The ADCC 30 includes a main control and algorithm unit 31 that controls the operation and is responsible for carrying out the various algorithms outlined below. The ADCC has four main data containers, as described above: the object specifications table 32, the traffic map table 33, the information table 34 and the configuration table 35. The Network Object's system 37 represent the underlying business computerized systems (UCS). ADCC 30 reads from the Network Object's system information required for the object specification table 32, This information is published by the ADCC 30 to the T²WAN, for example the ADCC 30 reads the Network Object's opening hours and publish it using the WLAN/PAN communications module 36. The Network Object's location is set manually at installation. The ADCC transfers relevant information received in the information table 33 to the Network Object's system, for example transferring request from a vehicle for parking reservation.

The ADCC includes a component that enables controlling some of its functionality remotely over the T²WAN. For example, a maintenance center can ask one or more network objects to send their diagnostics logs to the maintenance center. Each network object keeps a diagnostics log of all the bugs and problems the process encounters during its operation. The command and the reply are sent using the SIM and/or IIM. Another example of remote controlling is software updates, whereby the maintenance center sends SIM and/or IIM containing new versions of software. The receiving ADCC receives the information and updates some or all of the software that runs the ADCC.

The ADCC may include a billing component that enables controlling the ADCC's usage according to the Network objects authorization. Such a billing component may include the providing of a license, distributed to users of devices that are part of the W²AN system (with ADCC components), for billing or alternative commercial purposes. For example, a limited usage license may be provided to a user of a device or vehicle, which enables usage of the device in the W²AN, according to chosen rules or conditions.

The following sections describe several algorithms used in the present invention. The “Traffic Status Map algorithm” demonstrates how the ADCC constructs and maintains the TSM. The “Information and Instant messages algorithm” outlines the way ADCC handles the different service messages. The “Communication Protocol algorithm” illustrates the communication protocol between two Network Objects. The last two algorithms describe the way ADCC handles the received information, the TSM in “Merging Traffic Status Maps algorithm” and the SIM/IIM in “Maintaining Information Tables algorithm”.

All of the algorithms include different parameters that control their functionality. In the following description the parameters are marked with one capital letter followed with two numbers, for example T11. All of the parameters are defined in the configuration table 25 and 35. The parameters are set when the ADCC is initialized, and optionally may be set wirelessly using the T²WAN. The values of the parameters are determined using simulations and feedbacks from running T²WAN networks.

Traffic Status Map Algorithm

The following algorithm describes how the vehicle's ADCC composes the Traffic Status Map (TSM) and how the ADCC of all Network Objects, moving and stationary, maintains the TSM:

1. Reading, storing and aggregating various parameters, typically taken from the vehicles Telematics system, during the vehicle's trip constructs the TSM. The TSM is a collection of Traffic Status Records (TSR). Each TSR may include the following parameters:

a. Reading location

b. Reading time

c. Direction of movement

d. Velocity

e. Lights status

f. Windshield Wiper status

g. Tracking control status

h. Engine RPM

In addition to the TSR there are some parameters that are common to all records in the TSM. The TSM Header includes the following parameters:

a. ID of the Network Object

b. License ID of the sending network object

c. TSM time stamp—last time it was modified

d. TSM priority—indicates if the TSM includes records with high priority, such as sudden velocity change or whether vehicle tracking system on.

2. The ADCC reads the current vehicle location and direction periodically each T11 time to record the vehicle's path. T11 refers to a chosen time interval for which the ADCC requests data updates from the vehicle Telematics system. Each reading records the location, direction and time. The parameter T11 is proportional to the vehicle's velocity, such that the faster the vehicle goes, the smaller T11 is. The value of T11 must be small enough so that the vehicle path can be tracked, but not too small to prevent overload of unnecessary data.

3. When any of the TSM parameters change (beside location, time and direction), the parameter is recorded along the current location, time and direction. For each TSM parameter there is a predefined threshold H11. H11 refers to a minimum chosen limit, above or below which data changes are deemed relevant, such that when the parameter moves beyond the threshold, it is registered by the ADCC as a change. The threshold H11 depends on a parameter value, such as velocity (V). For example, if H11 is defined as a 33% change at speed of V=30 KMH, a change to V=20 KMH (33%) would activate a reading, however at V=100 KMH, H11 may be defined as 20%, and then only a change to V=80 KMH would activate reading.

For each H11 there is an H12, which is a larger threshold. H12 is defined according to a minimum chosen limit for which a change is considered with high priority. Setting the TSM priority to high effects the TSM exchange with other Network Objects and may result in a notification to the drivers in their Telematics system. The present invention is also able to differentiate between various traffic conditions, such as slowing down for a traffic light and for an emergency stop. This is enabled by the presence of a number of ADCC units, in vehicles, service stations etc., plus the optionally presence of ADCC units on traffic lights and at major intersections etc.

4. Information about location and speed are gathered using the GPS module (or alternative geographic location systems). The lights, wipers, RPM and tracking information are gathered from the vehicle's Telematics system.

5. The direction parameter is calculated as the direction (ΔX/ΔY) between the current TSR location and the last TSR location.

6. The TSM may be compressed in order to reduce the amount of memory required. Only the first reading stores the actual value of the parameters, and all later readings store only the changes.

7. ADCC performs periodic maintenance each T12 time: T12 time is defined by a chosen interval for which the ADCC performs internal maintenance of the TSM. The periodic maintenance includes:

a. Old (time) and remote (space) are thereby deleted. Another parameter, T13, is configured in order to determine what is the time to live of TSR. T13 may also depend on the time of day, for example; T13 is larger at midnight that in rush hour. There is an additional parameter, D11 that defines what the maximum distance that TSR must be kept. All the TSR in the distance greater than D11 are subsequently deleted. D11 depends on the location of the ADCC.

b. Redundant location and direction reading are removed. A redundant reading is when the direction change is less than H13 threshold, compared to the previous and in the next reading.

8. When memory limit of the TSM is reached, such as the case where there is an excessive quantity of TSRs, are deleted according to the following criterion:

a. Distance information, H14 percent of the most distant TSR are deleted.

b. Old information, H15 percent of the oldest TSR are deleted.

The deletion process in iterative, if after deleting old and distance TSR there is not enough space the delete process will be run again, while increasing H14 and H15.

9. Information unrelated to traffic is ignored. ADCC does not record parameters in the following cases:

a. When the parameter RPM is zero, it assumes that the vehicle is parking and obviously does not indicate the traffic pattern of this road.

b. When the location of the vehicle doesn't change more than T14 time more than D12.

10. Each ADCC is assigned a unique Network Object ID from a central location when created. The unique Network Object ID is not changed during the life of ADCC. All messages originating from the Network Object carry this unique ID.

11. Each ADCC is assigned a license ID from a similar central location when created. The license ID ensures the authentication of the ADCC. The license ID can be revoke or extended wirelessly using IIM.

Information and Instant Messages Algorithm

The following algorithm outlines the way the ADCC handles the different service messages (Service Information Messages (SIM) and Instant Information Messages (IIM)) that the Network Objects use:

1. Network Objects can publish their available services to the network by sending SIM. For example, gas stations can send information about opening hours and current gas prices. Each service provider can publish one or more SIM. Each SIM may contain the following parameters:

a. ID of the Network Object that initiates the SIM

b. License ID of the sending network object

c. Physical location of Network Object that initiates the SIM (only if needed)

d. Message ID, which is a unique identifier of the message for the initiating Network Object.

e. Message version. In case of a new message replacing an existing message, this field contains the message version.

f. The range on the SIM (kilometers). When going beyond the boundary the SIM is eliminated.

g. The time to live of the SIM (minutes). When time to live arrives, the SIM is eliminated

h. Message priority

i. Network Object group. Each Network Object can belong to one or more groups. Examples to groups are hotels, restaurants, and service stations.

j. Message information type indicates the type of information of the message. Two common information types are: content data, where the information field contains data for the ADCC; and control data, where the information field contains control commands to the ADCC.

k. Information specific to the Business/Maintenance. In the gas station example this, field may contain information about opening hours and prices of gas.

2. There are several types of information published by the SIM, including:

a. Business information such as service stations, fast food, parking garages and tourist attractions.

b. System maintenance information such as software updates and billing.

c. Telematics system updates, such as navigation-maps updates, Telematics systems updates.

3. Network Objects can send Instant Information Messages (IIM). The IIM is used for instant messaging between two or more Network Objects. For example, a vehicle can send IIM to parking garages looking for available space. Then, parking garages will response, using IIM, with relevant information. The vehicle can also use the IIM to make a reservation and payment, and receive confirmation. The IIM may typically include the following parameters:

a. ID of the Network Object that initiates the IIM

b. License ID of the sending network object

c. Physical location of the Network Object that initiates the IIM (only if needed)

d. Message ID, which is a unique identifier of the message for the initiating Network Object.

e. If a reply message, the message ID that of the receiving Network Object. For example, a vehicle sends an IIM to make a reservation at a parking garage, and the parking garage sends a reply IIM with the confirmation.

f. The range on the IIM (kilometers). When going beyond the boundary, the IIM is eliminated.

g. The time to live of the IIM (minutes). When the time to live arrives, the IIM is eliminated.

h. The destination of the messages. The destination can be broadcast to all Network Objects or groups of Network Objects. For example, requests for available accommodations for hotels. If the message is for a specific destination, one or more stationary or mobile Network Objects their physical location and Network Object ID is included.

i. Current velocity and direction (only if needed). This field is sent in the case where a moving Network Object sends a message with its location, so that other Network Objects will be able to estimate its future location for replay.

j. Message priority

k. Message information type indicates the type of information of the message. Two common information types are: content data, where the information field contains data for the ADCC; and control data, where the information field contains control commands to the ADCC.

l. Information specific to the message. For example, when looking for accommodation, the vehicle may send an IIM message that includes information about arrival time, price range and type of hotel. The hotel will replay/respond with an IIM that includes information about availability.

4. The Network Object's Available Information Table (AIT), that is stored in the object specification table 22/32, contains all SIM that the Network Object wants to publish in the network constantly. The Network Object can also store, in the AIT, IIMs that the Network Object wants to publish. Such IIMs are usually sent on demand for short periods of time. Each type of Network Object has a different set of messages. Following is an example of types of messages:

a. Information about the Network Object, such as address, phones, email, web sites

b. Opening hours information

c. Availability of different products

d. Pricing for different products

e. Special deals

f. List of Available Messages (LAM) for the network object (see below)

g. Transactional messages

5. The IIM is used for instant messaging between Network Objects. IIM contains special information transferred between Network Objects for certain purpose. An example for an IIM is a vehicle sending IIM to query about parking availability and to make a reservation. Then the garage responds, using an IIM, with confirmation.

6. The AIT is built either especially for the Network Object using a special build interface, or where there is underlying-computerized system (UCS), such that it contains the needed information by querying the UCS.

7. The creator of the SIM/IIM defines its time and location to live according to the requirements from the SIM/IIM.

8. IIM is built on demand: when user requests information, in response to some external event or in response to another IIM.

9. There are two types of IIM, according to their destination

a. Broadcast IIM (BIIM) are sent from a Network Object to all or groups of destinations, but not to specific destinations. For example BIIM can be send to all the hotels in the area.

b. Narrowcast IIM (NIIM) are narrowcast data transfers sent from a Network Object to one or more specific destinations, for example NIIM can be sent to a hotel with specific Network Objects ID, in order to make a reservation.

10. Network Objects retransmit all of the SIM and IIM in the AIT, each T21 time.

11. Network Objects continually transmit the SIM; the IIM is transmitted for N21 times, where N21 depends on the specific IIM.

12. Each message has a priority for transfer in the network. The message creator sets the priority. The AIT priority is set as to the priority of the message with the highest priority. T21 depends on the AIT priority, since the higher the priority, the smaller T21 is.

13. Each group of Network Objects has a List of Available Messages (LAM). There is a LAM of hotels, restaurants, parking garage etc. The LAM is transmitted to the vehicles so that they will be able to know what types of information they can request from each type of stationary Network Object.

14. In transactional messages the ADCC needs to perform a query into the Network Object's underlying computerized systems (UCS) to get the message information. For example a parking garage can maintain a list of available space. When a vehicle sends an IIM to make a reservation, the ADCC of the parking garage finds the availability by querying the underlying availability list and returning a response to the vehicle.

15. Each ADCC is assigned a unique Network Objects ID from a central location when created. The unique Network Objects ID is not changed during the life of ADCC. All messages originating from the Network Object carry this unique ID.

16. Each ADCC is assigned a license ID from a similar central location when created. The license ID ensures the authentication of the ADCC. The license ID can be revoke or extended wirelessly using IIM.

17. The physical location of stationary Network Objects is published so that other Network Objects can always send them specific messages. The stationary Network Object location is published using the SIM.

18. Vehicles usually don't publish their location in the SIM and IIM. This is done to keep the drivers privacy. The only case where vehicles publish their locations is when they want a replay. For example, a vehicle sending IIM for parking reservation when wanting to receive an acknowledgment.

19. When the ADCC creates a narrowcast IIM (NIIM) it needs to calculate the location to live of the NIIM according to the path between the source and destination, the ADCC calculates the location range as the area that covers the path between the source and all destinations. The path is defined as the geographical area between the source and destination with some width D21. The allowed deviation of the width (D21) from the strait line path depends on the vehicles speed.

20. When replaying to a vehicle its destination location is estimated by the sending ADCC. The estimated replay location is calculated using the vehicle previous location, velocity and direction taken from the query IIM.

Communication Protocol Algorithm

The communications protocol comprises the following elements:

1. It is assumed that the underlying WLAN/PAN connection ensures reliable, secure connection between the Network Objects.

2. There are two possible ways of communication.

a. Point-to-Point: Two Network Objects talking with each other.

b. One to many: one Network Object can talk simultaneously to several Network Objects.

3. There are two modes of communication, depending on the WLAN/PAN technology:

a. Half duplex—one network object transmits and the other receives.

b. Full duplex—both network objects transmit and receive simultaneously.

4. The following is an example of technologies that offer LAN/PAN wireless connection:

a. Bluetooth

b. Dedicated Short Range Communications (DSRC)

c. 802.11b/802.11a

d. Digital Enhanced Cordless Telecommunications (DECT)

e. UWB—Ultra wide band

5. There are three types of information that are transferred between Network Objects

a. Traffic Status Map (TSM)

b. Service Information Messages (SIM)

c. Instant Information Messages (IIM)

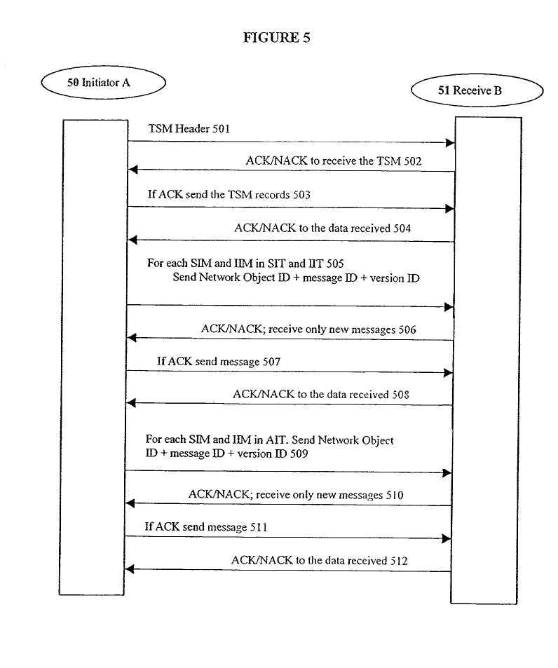

6. FIG. 4 illustrates the general flow diagram representing the main activities, according to a preferred embodiment of the present invention. In the idle state, the system listens to the communication line and waits 41 for communication from other Network Objects. Once the Network Object becomes aware that another Network Object is trying to send it information (incoming message) 42, the (receiving) Network Object enters into receive state in order to receive the information 43. At the end of receiving information, the received information is merged with ADCC existing information 44, whereby the underlying Network Object is updated with new data 45, the system enters into transmit state 46 to transfer the received information to the other surrounding Network Objects. The system can also enter into the transmit state if predefined events occur, such that a transmit query is satisfied. For example, a message waiting to be transferred more than a predefined number of times 47.

7. The transmission range depends on the concentration of Network Objects. First the Network Objects try to transmit to small distances to reduce the chance of interferences with other communicating Network Objects. If the Network Object cannot communicate with other Network Objects in that distance, it increases its communication range until, either reaching the maximum WLAN/PAN range, depending on the technology used, or engaging in communication with another Network Object.

8. There are three tables that hold SIM and IIM for exchange with other Network Objects:

a. Service Information Table (SIT) contains SIM received from the TW²AN, stored in the information table 24 and 34

b. Instant Information Table (IIT) contains IIM received from the TW²AN, stored in the information table 24 and 34

c. Available Information Table (AIT) contains all SIM and IIM originated from the Network Object, stored in specification table 22 and 32

9. FIG. 5 describes the communication dialog between two ADCC components.

Once there is a connection, Network Object A 50 sends it's TSM header 501 to Network Object B 51. If the data had not been previously received, Network Object B sends an Acknowledgment message (ACK) 502 to Network Object A, and subsequently the TSM content is sent 503 to Network Object B. At the end of transmission Network Object B replay with status of the received process 504 Similar procedure occurs for the sending/receiving of SIM and IIM 505,506,507,508 from Network Object A's SIT and IIT and sending/receiving SIM and IIM 509,510,511,512 from Network Object B's AIT. Is should be noted that all TSM/SIM/IIM are accompanied by TSM/message ID and version ID identifiers, so that only new TSM//SIM/IIM are receives/sent. After the Initiator A finished, the receiver B checks to see if it has any TSM, SIT, IIT or AIT to transfer back. If B has information to transfer, their roles are reversed and B become the initiator and A the receiver.

10. For clarity purposes, the previous section describes a communication protocol where there is a transmitter and a receiver. In the case where the WLAN/PAN technology enables full duplex communication, each network object may act as both receiver and transmitter simultaneously.

11. An Network Object tries to transmit information to other Network Objects only if it has a TSM or SIM or IIM to send. The following paragraphs describe when Network Object tries to send such a message. Network Objects agree to receive only new information, as is defined below.

12. Network Objects try to transmit TSM each T31 time. If T31 passed and there was no communications, T31 is decreases until it reach zero.

13. T31 depends on the TSM priority, such that when the priority is higher, T31 is smaller.

14. Network Objects don't receive more than one TSM from the same Network Object in T32 time. In all other cases Network Objects agree to receive any TSM. This rule does not apply to the case were the new TSM priority is higher than the one received before from the same Network Object. To support that requirement each Network Object maintains a table with all the Network Objects with which it exchanges TSM, within T32 time, according to TSM priority.

15. Network Object tries to transmit SIM/IIM under the following conditions:

a. Each T33/T34 time, if T33/T34 passed and there was no communications, T33/T34 decreases until it reaches zero.

b. A new SIM/IIM in the SIT/IIT/AIT resets the transmission delay. A new SIM/IIM can originate either from the Network Object's system or from other Network Objects.

16. T33/T34 depends on the SIT/IIT/AIT priority, such that when the priority is high, T33/T34 is smaller. When there are several SIM/IIM in the SIT/IIT/AIT the priority is defined according to the priority of the messages with the higher priority.

17. When exchanging SIT/IIT/AIT, the SIM/IIM is send in the order of their priority. SIM/IIM with high priority is send first. The next orders are executed according to time to live (descending), space to live (descending) and creation time (ascending).

18. Network Objects receive only new SIM/IIM. A SIM/IIM is new when a SIM/IIM with the same Network Object ID, message ID and version ID is not or was not in the SIT/IIT. The Network Object maintains a table with all SIM/IIM deleted from the SIT/IIT, in order to avoid receiving the same message again.

19. After receiving information, the ADCC checks how to handle it. The following algorithm “Combine different Traffic Maps” outlines handling TSM. SIM and IIM are added to the SIT/IIT as described in the following algorithm “Maintaining Service Tables”.

20. All communication between Network Objects is secure, using the WLAN/PAN encryption mechanisms. In addition, the ADCC may add a signature to each specific message, so that only the valid destination of that message is able to open it.

21. The ADCC may not allow the transmission of SIM/IIM from a network object that does not have a valid license.

Merging Traffic Status Maps Algorithm

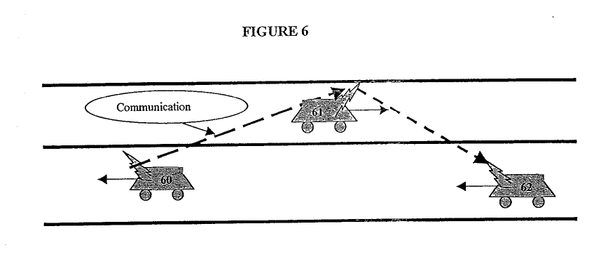

This algorithm describes the way the ADCC merges received TSM with the existing TSM. The TSM that is built internally by a vehicle is of little interest to the driver of the vehicle, since it only contains information about the path already traveled. However, by exchanging TSM, vehicles receive the TSM of the road ahead. FIG. 6 shows two vehicles 60 and 61 going in opposite directions of a road, where each has the TSM of the road behind them. In this case, when they exchange their TSMs, each will also have the information about the road ahead. At this stage, however, the information will be of the opposite lane. When vehicle 60 will exchange the TSM with another vehicle coming in the opposite direction 62, vehicle 62, having previously communicated with additional vehicles ahead of vehicle 61, will be able to provide the aggregate of such information, enabling vehicle 61 the ability to predict the road ahead.

This method enables vehicles to receive updated traffic and status maps even with low density of vehicles, primarily on the main roads where the probability of vehicles with ADCC meeting are relatively high, taking into account that the change rate of traffic is measured in tens of seconds.

The following outline the steps necessary to merge TSM:

1. When two Network Objects exchange TSM, each needs to build new a TSM, based on their existing TSM and the one they received.

2. Two TSR have similar positions only if the difference between the two locations of the TSR is smaller than some parameter H41, and the difference between the two directions is smaller that H42. Both the location and the direction of vehicles are used, because vehicles traveling in opposite direction do not have similar positions, even though they may have similar location due to the GPS resolution.

3. Both the existing TSM and the new received one are collections of TSR. In the merge process, the two collections are combined. The new TSM is a collection of both TSRs. When there are TSR with similar location and direction from different TSMs, the following occurs:

a. If all the other TSR parameters (besides location and direction) are similar, the difference between the parameters is less than some parameter H43, then the TSR with the oldest time stamp is deleted.

b. If there is a difference in the parameters of the similar TSR, and the difference between the time stamps of the two TSRs is more than T41, then the oldest TSR is removed.

c. If there is a difference in parameters of the similar TSR, and the time difference is less than H44, then the two TSRs are kept, and later when another TSR arrives, this new data will be use to decide.

4. If the merge TSM reached the allowed memory limit, information (TSRs) is deleted according to the following criterion:

a. Distance information, such that H45 percent of the most distant TSR are deleted.

b. Old information, such that H46 percent of the oldest TSR are deleted.

The deletion process in iterative, and if after deleting old and distance TSR there is not enough space, the delete process is run again, while increasing H45 and H46.

5. The merge TSM needs to be converted for the Telematics system from discrete TSR into continues information presented on the road map. The transformation from location reading to road numbers is done using the underlying navigation system that is part of the vehicle's Telematics system. The navigation system receives a discrete set of location reading (GPS) data and finds the road numbers and direction of movement. The discrete readings are converted into continues information by extrapolating the TSR.

6. The merged TSM is stored in the ADCC and presented to the user through the Telematics system. The new TSM will be transferred to the Telematics systems only if the ADCC has a valid license.

7. In applications that require historic TSM rather than current TSM, all of the received TSM are kept without any deletion. For example, an application that analyzes traffic patterns for future predictions requires historic TSM. In additio to presenting the current traffic, the UCS may contain a separate unit for traffic forecasting. Forecasts, such as time of arrival to a destination and duration of traffic jams, are typically enabled using historic TSM.

Maintaining Information Tables Algorithm

The following outlines the necessary steps taken by ADCC to maintain the SIT and IIT

1. Once a Network Object received a SIM/BIIM, it is added to the Network Object's SIT/IIT. If the Network Object is a valid destination and the ADCC has a valid license, the newly received SIM/BIIM is transferred to the underlying Telematics system and the ADCC handles it according to its type.

2. If the newly received SIM/IIM information type is a control data type, it is handled by the ADCC, according to the information in the message. For example, if the message information contains a command to perform a software update, the ADCC updates its software with the new version that was supplied.

3. Received SIM with the same Network Object ID and message ID but a different version ID from existing SIM in the SIT, will overwrite the existing SIM.

4. Received SIM/IIM in which time to live is over, are deleted. If the current Network Object location is outside the location to live of the SIM/IIM, the SIM/IIM are also deleted.

5. Received NIIM are added to the Network Object's IIT. If the Network Object is a valid destination and the ADCC has a valid license, the newly received NIIM is transferred to the underlying Telematics system and handled in the ADCC, according to its type. If the Network Object is the only destination of the message, the NIIM is deleted from the IIT.

6. If the merge SIT/IIT reached the allowed memory limit, information is deleted according to the following criterion:

a. Distance information, such that H51 percent of the SIM with the greatest distance location to live are deleted.

b. Old information, such that H52 percent of the SIM with the shortest time-to live are deleted.

c. SIM/IIM that were not transferred to any other Network Object are deleted last.

The deletion process in iterative, such that if after deleting old and distance TSR there is not enough space the process, the delete process is run again, while increasing H51 and H52.

7. Only SIM/IIM with valid licenses is presented to the Telematics system.

Alternate Embodiments

Several other embodiments are contemplated by the inventors, including:

A system and method for enabling marine vehicles (boats etc) to exchange information in a way similar to the described system for vehicles. Instead of traffic information the marine information includes parameters such as: sea level wind, temperature, barometric pressure etc.

A system and method for enabling aviation vehicles (airplanes etc) to exchange information in a way similar to the described system for vehicles. Instead of traffic information, the aviation information may include parameters such as: storms, clouds, temperature, wind, barometric pressure etc.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A Wireless Wide Area Network (W²AN), comprising:
i. a plurality of Network Objects; and
ii. an Aggregating Disseminating Communication Component (ADCC) for each said Network Object, for processing data in each network object, and enabling communication of relevant data between said plurality of network objects.

2. The system of claim 1, wherein said Network Objects are objects within domains selected from the group consisting of automobile, marine and aviation domains.

3. The system of claim 2, wherein said network objects integrate Telematics related data from a plurality of network objects, thereby enabling formation of a Telematics W²AN (TW²AN).

4. The system of claim 3, wherein said TW²AN enables transferal of information types selected from the group consisting of Traffic status maps (TSM); Service Information Messages (SIM); and Instance Information Messages (IIM).

5. The system of claim 1, wherein said Network Object is selected from the group consisting of stationary objects and mobile objects.

6. The system of claim 5, wherein said stationary objects further comprise:
i- an Underlying Computer System (UCS); and
ii- a network wireless communication unit

7. The system of claim 5, wherein said stationary objects are selected from the group of Network Objects consisting of Businesses, hotels, parking garages, restaurants, tourist attractions, maintenance centers, control towers, weather stations, and light houses.

8. The system of claim 5, wherein said mobile objects further comprise:
i) a Telematics system;
ii) a network wireless communication unit; and
iii) a geographical positioning system unit.

9. The system of claim 5, wherein said mobile Network Object systems are selected from the group of Network Objects consisting of automobiles, surface vehicles, ships, marine vehicles, airplanes, air vehicles and satellites.

10. The system of claim 1, wherein said ADCC further comprises:
a) a Main Control and Algorithm Unit (MCAU), for controlling the ADCC;
b) database tables, for storing information used by said MCAU; and
c) an interface to said network communications component.

11. The system of claim 10, wherein said ADCC, when in a stationary object, further comprises:
d) an interface to said object's underlying computerized system (UCS).

12. The system of claim 10, wherein said ADCC, when in a dynamic object, further comprises:
e) an interface to said geographical positioning system unit;
f) an interface to Telematics System (TS) of said object.

13. The system of claim 10, wherein said MCAU further comprises:
a. means for configuring said Network Object and said ADCC parameters from said TW²AN;
b. means for controlling said Network Object and said ADCC parameters from said TW²AN and
c. means for central control and synchronization between different components of said ADCC.

14. The system of claim 13, further comprising means selected from the group consisting of:
d. a Billing means for ensuring that said Network Objects participate in said TW²AN in accordance to object authorization;
e. a handling Traffic Status Map (TSM) means for enabling said ADCC to construct and maintain said TSM;
f. a handling Service Information Message (SIM) means and a handling Instant information messages (IIM) means for constructing and maintaining messages;
g. a Communication protocol for enabling communication between a plurality of said Network Objects;
h. a Merging traffic status maps means, for enabling handling of received TSM from said remote ADCC and merging said received TSM with internal TSM; and
i. a Maintaining information tables means, for enabling handling of received SIM and IIM, from said remote ADCC and merging said received SIM and IIM with internal SIM and IIM respectively

15. The system of claim 10, wherein said database tables means further comprises tables selected from the group consisting of:
I. an object specifications table, for storing information for publishing to said TW²AN;
II. a traffic map table, for storing current TSM of said object;
III. an information table, for storing SIM and IIM from said TW²AN; and
IV. a configuration table, for configuring parameters of operation of said ADCC.

16. The system of claim 4, wherein said SIM provides data to said TW²AN from mobile and stationary network objects, said SIM further comprising:
I) identification of a sending network object;
II) message time to live and space to live data;
III) message priority data;
IV) message version data;
V) message information type; and
VI) message information data.

17. The system of claim 16, wherein if said data providing network object is stationary, said SIM further compromises location data of sending network object.

18. The system of claim 16, wherein if said network object is mobile and said network object requires a reply from a second network object, said SIM further compromises location data, velocity data and direction data of sending network object.

19. The system of claim 4, wherein said IIM provides means for network objects to send short-lived (instant) messages to other network objects, said IIM further comprising:
I- identification of a sending network object;
II- message time to live and space to live data;
III- message priority data;
IV- message version data;
V- message destination identification address;
VI- message information type; and
VII- message information data.

20. The system of claim 19, wherein if said data providing network object is stationary, said IIM further compromises location data of sending network object.

21. The system of claim 19, wherein if said network object is mobile and said network object requires a reply from a second network object, said IIM further compromises location data, velocity data and direction data of sending network object.

22. The system of claim 4, wherein said IIM further comprises messages selected from the group consisting of:
(i) broadcast IIM (BIIM), for disseminating said IIM to a plurality of said network objects; and
(ii) narrowcast IIM (NIIM), for disseminating said IIM to a specific said network object.

23. The system of claim 4, wherein said TSM provides means for network objects to aggregate, publish and receive traffic maps, said TSM further comprises:
I) identification of a sending network object;
II) message time to live and space to live data
III) message priority data; and
IV) message information data of said object, said message information data being a collection of Traffic Status Records (TSR).

24. The system of claim 23, wherein each said TSR has a time and location stamp of a reading, and at least one parameter selected from the group of relevant Telematics parameters consisting of Velocity, Direction of movement, Lights status, Wiper status, Tracking system status, wind speed, cloud density, temperature, barometric pressure, and Engine RPM.

25. The system of claim 14, wherein said communication protocol further comprises:
a- network technologies for connecting said Network Objects;
b- a plurality of message types for defining messages for transfer between said Network Objects, said types selected from the group consisting of TSM, SIM and IIM;
c- tables in each said Network Object, for storing and managing data messages;
d- means for adaptive communication range according to density of said network objects.

26. A method for aggregating and disseminating data between a plurality of remote Network Objects in order to form a Wireless WAN (W²AN), comprising the steps of:
i. compiling network object internal information, by an Aggregating Disseminating Communication Component (ADCC) within each of the network objects;
ii. Communicating said network object internal information between at least two network objects;
iii. merging received said first network object internal information with internal information of said second network object as said second network object's new internal information;
iv. transferring relevant information to Underlying Computer System (UCS) of said second network object.

27. The method of claim 26, wherein said network objects operate in a domain selected from the group consisting of automobile, marine and aviation domains.

28. The method of claim 27, wherein said domains enable the wireless communication of Telematics related data, thereby forming a Telematics Wireless Wide Area Network (TW²AN).

29. The method of claim 28, wherein said TW²AN enables communication of various types of data between the remote Network Objects, selected from the group consisting of Traffic Status maps (TSM), Service Information (SIM), and Instant Information Messages (IIM).

30. The method of claim 29, wherein said IIM further comprises messages selected from the group consisting of:
i- broadcast IIM (BIIM); and
ii- narrowcast IIM (NIIM).

31. The method of claim 26, further comprising the step of swapping roles of said first network object and said second network object, such that said first network object becomes an information receiver, and such that said second network object becomes an information transmitter.

32. The method of claim 26, further comprising transmitting a request to at least a third network object, for sending said new internal information to said at least a third network object.

33. The method of claim 26, wherein said compiling of network object internal information further comprises the compiling of data types selected from the group consisting of Traffic Status Maps (TSM), Service Information Messages (SIM), and Instant Information Messages (IIM).

34. The method of claim 33, wherein said TSM is complied according to the steps of:
a. reading and storing vehicle internal parameters periodically to said ADCC;
b. reading and storing said vehicle internal parameters to said ADCC when one of said parameters change outside a predefined threshold; and
c. ignoring information unrelated to traffic based data.

35. The method of claim 26, wherein said communication of said network object's internal information, comprises the steps of:
i. transmitting a request to at least one second network object, for sending said internal information, by said first network object;
ii. sending an acknowledgment of said request to said first network object, by said second network object, that said second network object is prepared to receive said internal information from said first network object;
iii. transferring said internal information to said second network object, by said first-network object; and
iv. receiving said first network object internal information, by said second network object.

36. The method of claim 26, wherein said communication further comprises simultaneous communication of network object internal information between at least two said network objects.

37. The method of claim 26, wherein said communication only occurs when there is at least one additional network object within said first object's communication range.

38. The method of claim 35, wherein said transmitting a request to a second said network object to send said internal information, is executed in a way selected from the group consisting of periodically transmitting; immediately transmitting when new information is received by said first network object; and immediately transmitting when some query is met.

39. The method of claim 35, wherein said receive process further comprises the steps of:
a- listening to a communication line for a request to send information from a first network object;
b- when receiving said request, checking if proposed information is new information;
c- if said proposed information is new, receiving said new information;
d- if said proposed information is not new, declining said new information;
and
e- after receipt of said new information, said second object sends information to a third object.

40. The method of claim 26, wherein said merging of received said network object internal information further comprises the merging of data types selected from the group consisting of current Traffic Status Maps (TSM), historic Traffic Status Maps (TSM), Service Information Messages (SIM), and Instant Information Messages (IIM).

41. The method of claim 40, wherein said current TSM is merged according to the steps of:
A- building a new TSM, by merging a received Traffic Status Record (TSR) with an existing TSR in an existing TSM;
B- keeping said TSR that is most relevant in said new TSM, according to a time data criterion; and
C- if there are memory space limitations, deleting least relevant TSR, according to criteria selected from the group consisting of time data and space data.

42. The method of claim 26, wherein said transferring relevant information to said Underlying Computer System (UCS) further comprises the transfer of data types selected from the group consisting of Traffic Status Maps (TSM), Service Information Messages (SIM), and Instant Information Messages (IIM).

43. The method of claim 42, wherein said TSM is transferred to said Underline Computerized System (UCS) of a network object, according to the steps of:
A: converting a new collection of discrete TSR to a continuation map, said map including road information and direction of movement data; and
B: transferring said continuation map to said object's UCS, for presentation to said object's user.

44. A method for forming a Wireless Wide Area Network (W²AN) without the need of external network infrastructure, comprising the steps of:
i. setting up a plurality of Aggregating Disseminating Communication Component (ADCC) components, each said ADCC component located in each of at least one Network Object;
ii. configuring said ADCC components to enable communication of Network Object data for each said Network Object; and
iii. communicating said Network Object data between at least two said Network Objects, by means of exchanging information between two ADCC components, via wireless telecommunications technology.

45. The method of claim 44, wherein said Network Object data is selected from the group consisting of surface related data, marine data and aeronautical data.
